(19) United States
(12) Patent Application Publication
(10) Pub. No.: US 2010/0134916 A1
(43) Pub. Date: Jun. 3, 2010

(54) MAGNETIC RECORDING MEDIUM AND MAGNETIC STORAGE DEVICE

(75) Inventor: Takayuki KAWABE, Sagamihara-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/629,809

(22) Filed: Dec. 2, 2009

(30) Foreign Application Priority Data
Dec. 2, 2008 (JP) 2008-308006

(51) Int. Cl. G11B 21/02; G11B 5/706

(52) U.S. Cl. 360/75; 428/848; G9B/21.003

(57) ABSTRACT

According to one embodiment, a magnetic recording medium includes a disc substrate, a first recording layer, and a second recording layer. The first recording layer is disposed in at least one of a plurality of data storage areas partitioned in a radial direction on the disc substrate. A magnetic material is deposited on the first recording layer. The second recording layer is disposed in the data storage areas except the data storage area where the first recording layer is disposed. The second recording layer includes a magnetic material and a non-magnetic material that are alternately arranged in the in-plane direction of the upper surface of the disc substrate.

### CROSS-REFERENCE TO RELATED APPLICATIONS

This application is based upon and claims the benefit of priority from Japanese Patent Application No. 2008-308006, filed Dec. 2, 2008, the entire contents of which are incorporated herein by reference.

### BACKGROUND

1. Field

One embodiment of the invention relates to a magnetic recording medium and a magnetic storage device.

2. Description of the Related Art

In a magnetic storage device (a hard disc drive (HDD)), a magnetic disc medium has been commonly used as a magnetic recording medium. The magnetic storage device of this type employs a carriage component of a swing arm type for holding a magnetic head to reduce the size and increases the access speed of the magnetic head. The carriage component receives force from a voice coil motor (VCM) at a point of effort located on a terminal of a pivot and swings the magnetic head provided to a point of load located on the other terminal. Due to the swing, the magnetic head is positioned at a radial position of the magnetic disc medium. In this case, the magnetic head moves along a circular orbit centering on the pivot and thus has a skew angle to a track according to the radial position where it is positioned on the medium.

If an adjacent track is affected by a leakage magnetic field from the magnetic head due to the skew angle, information written in the adjacent track may be lost or noise may be recorded on the adjacent track. For this reason, as a technology for avoiding such phenomena and achieving high recording density, a discrete track recording (DTR) technology recently attracts attentions.

In the discrete track recording technology, as illustrated in FIGS. 15A and 15B which is a cross-sectional view taken along line A-A′ of FIG. 15A, a magnetic material 204 applied to a disc substrate 202 is partitioned by a non-magnetic material 206 in the circumferential direction to form concentric circular tracks. With this, magnetic interference between adjacent tracks is reduced, and it becomes easy to approximate track pitches, whereby recording density can be improved.

The magnetic head which performs recording or reproducing of magnetized information with respect to the magnetic recording medium is formed on a wafer through microfabrication. However, if the magnetic head is formed using microfabrication, the core width of the magnetic head is likely to vary. Further, since the track pitch on the magnetic recording medium is affected by the core width of the magnetic head, an optimum track pitch of the magnetic recording medium varies depending on the core width (formation variation) of the head.

Recently, technologies have been proposed in which an optimum track pitch is set for each head by, for example, multiplying a track pitch obtained from previously written servo information by a coefficient according to a radial position of a magnetic recording medium where the head is positioned (see, for example, Japanese Patent Application Publication (KOKAI) No. 2005-071433).

However, in the discrete track recording technology described above, since a track is previously formed on a disc, an optimum track pitch cannot be set for each head according to the core width of the head.

That is, in the discrete track recording technology, since the recording density is uniform regardless of the core width of the head, the recording density cannot be changed according to the core width of the head.

Japanese Patent Application Publication (KOKAI) No. 2006-048751 discloses a conventional technology for dealing with the influence of a leakage magnetic field according to the radial position of a magnetic recording medium where the magnetic head is positioned, such as skew angle, even in the discrete track recording technology. In the conventional technology, the influence of a leakage magnetic field is reduced by a configuration in which the width of a non-magnetic material guard band of the medium is increased at a position with a large skew angle. The conventional technology is not capable of adjusting the recording density according to variations in core width which varies depending on each head.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a configuration of a magnetic disc device according to a first embodiment of the invention;

FIG. 2 is an exemplary enlarged view of a recording element and a reproducing element provided to a head slider in the first embodiment;

FIG. 3 is an exemplary schematic diagram of a relationship between a radial position where the head slider is positioned and a skew angle in the first embodiment;

FIG. 4A is an exemplary plane view of a magnetic disc in the first embodiment;

FIG. 4B is an exemplary cross-sectional view of the magnetic disc in the first embodiment;

FIGS. 5A to 5L are exemplary schematic diagrams for explaining how to manufacture the magnetic disc of FIGS. 4A and 4B in the first embodiment;

FIGS. 6A to 6C are exemplary schematic diagrams for explaining a recording method using the magnetic disc of FIGS. 4A and 4B in the first embodiment;

FIGS. 7A and 7B are exemplary schematic diagrams of a comparison example of FIGS. 6A to 6C in the first embodiment;

FIG. 8 is an exemplary schematic diagram of a track number conversion table in the first embodiment;

FIG. 9 is an exemplary schematic diagram of a relationship between a radial position where a head slider is positioned and a skew angle according to a second embodiment of the invention;

FIG. 10A is an exemplary plane view of a magnetic disc in the second embodiment;

FIG. 10B is an exemplary cross-sectional view of the magnetic disc in the second embodiment;

FIG. 11 is an exemplary schematic diagram of a relationship between a radial position where a head slider is positioned and a skew angle according to a third embodiment of the invention;

FIG. 12A is an exemplary plane view of a magnetic disc in the third embodiment;

FIG. 12B is an exemplary cross-sectional view of the magnetic disc in the third embodiment;

FIG. 13 is an exemplary view of the magnetic disc in which servo pattern areas are provided;

FIGS. 14A to 14C are exemplary schematic diagrams for explaining the case where the cross-sectional shape of a recording element is an isometric trapezoid shape;

FIG. 15A is an exemplary plane view of a magnetic disc according to a conventional discrete track recording (DTR) method; and

FIG. 15B is an exemplary cross-sectional view of the magnetic disc of the conventional DTR method.

### DETAILED DESCRIPTION

Various embodiments according to the invention will be described hereinafter with reference to the accompanying drawings. In general, according to one embodiment of the invention, a magnetic recording medium comprises a disc substrate, a first recording layer, and a second recording layer. The first recording layer is configured to be disposed in at least one of a plurality of data storage areas partitioned in a radial direction on the disc substrate. A magnetic material is deposited on the first recording layer. The second recording layer is configured to be disposed in the data storage areas except the data storage area where the first recording layer is disposed. The second recording layer comprises a magnetic material and a non-magnetic material that are alternately arranged in the in-plane direction of the upper surface of the disc substrate.

According to another embodiment of the invention, a magnetic storage device comprises a magnetic head, a head mount component, and a driving mechanism. The magnetic head is configured to perform magnetic recording and reproducing of information with respect to a magnetic recording medium. The magnetic recording medium comprises a disc substrate, a first recording layer, and a second recording layer. The first recording layer is configured to be disposed in at least one of a plurality of data storage areas partitioned in a radial direction on the disc substrate. A magnetic material is deposited on the first recording layer. The second recording layer is configured to be disposed in the data storage areas except the data storage area where the first recording layer is disposed. The second recording layer comprises a magnetic material and a non-magnetic material that are alternately arranged in the in-plane direction of the upper surface of the disc substrate. The head mount component is configured to support the magnetic head. The driving mechanism is configured to swing the head mount component around a pivot and position the magnetic head on the first recording layer or the second recording layer.

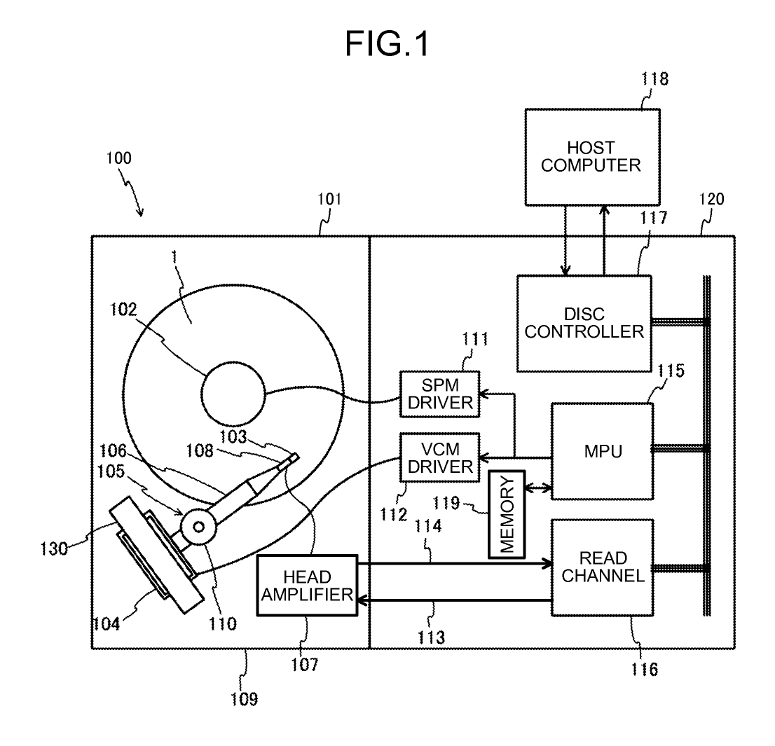

A first embodiment of the invention will be described in detail with reference to FIGS. 1 to 8.

FIG. 1 illustrates a configuration of a magnetic storage device (a hard disc drive (HDD)) 100 according to the first embodiment. In the first embodiment, the magnetic storage device 100 has a discoidal magnetic recording medium (a magnetic disc) 1 and thus is hereinafter referred to as “magnetic disc device 100”.

As illustrated in FIG. 1, the magnetic disc device 100 comprises a disc enclosure 101 and an electrical circuit board 120.

The disc enclosure 101 comprises the magnetic disc 1, a spindle motor (SPM) 102 which supports and revolves the magnetic disc 1, a head slider 103, a carriage actuator 105 as a head mount component, a head amplifier 107, and a case 109 which receives and seals the respective components.

The carriage actuator 105 comprises a carriage arm 106, a head gimbal assembly (HGA) 108 which is disposed on a terminal of the carriage arm 106 and supports the head slider 103, a coil 104 disposed on the other terminal of the carriage arm 106, and a shaft 110 as a pivot. A driving mechanism (VCM) is configured by the coil 104 and a magnet (not illustrated) which is disposed to surround the coil 104 and attached to a yoke 130.

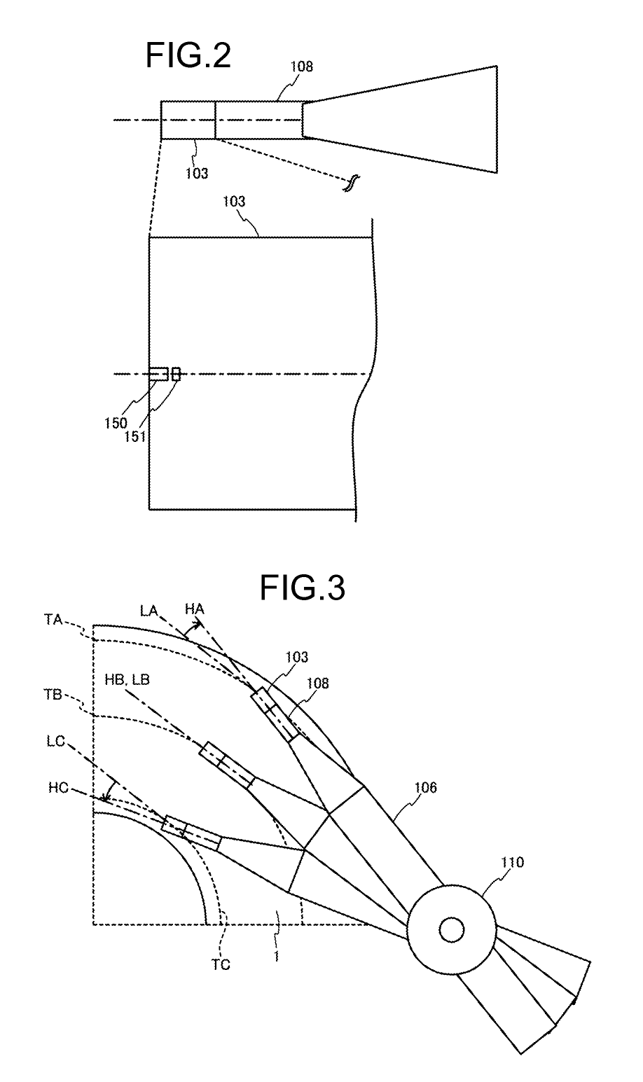

The head slider 103 is mounted in an end portion of the HGA 108 and is flying over the magnetic disc 1 with a predetermined gap. The head slider 103 comprises a recording element 150 for recording magnetic information in the magnetic disc 1 and a reproducing element 151 for extracting magnetic information recorded in the magnetic disc 1 as electrical signals as illustrated in FIG. 2. The recording element 150 comprises, for example, a write coil having a function of generating magnetic flux, a main magnetic pole layer for receiving the magnetic flux generated by the write coil and emitting the magnetic flux toward the magnetic disc 1, and an auxiliary magnetic pole layer for circulating the magnetic flux emitted from the main magnetic pole layer through the magnetic disc 1. As the reproducing element 151, for example, a MR element (a magnetic resistance effect element) is used. A magnetic head is configured by the recording element 150 and the reproducing element 151.

An end portion of the HGA 108 in which the head slider 103 is not mounted is fixed to a front end of the carriage arm 106. Therefore, the carriage arm 106 receives driving force from the driving mechanism (VCM) and is rotated around the shaft 110 as a pivot. Accordingly, the head slider 103 is driven and swings, and is positioned at an arbitrary radial position of the magnetic disc 1. In a state in which the head slider 103 is positioned at a desired track on the magnetic disc 1, the head slider 103 writes information in a recording bit disposed in a recording track by using the recording element 150 or reads information from the magnetic disc 1 by using the reproducing element 151.

FIG. 3 illustrates a relationship between a position determination position (a radial position of the head slider 103) and the skew angle. As illustrated in FIG. 3, when the head slider 103 is positioned at an almost center (a middle diameter area) of the magnetic disc 1 in a data storage area in which data recording or reproducing of the magnetic disc 1 is performed, a tangential direction LB of a track TB is almost identical to a direction (a direction which connects a center of the reproducing element 151 with a center of the recording element 150) HB of the head slider 103. When the head slider 103 is positioned near an edge of an outer diameter area of the data storage area of the magnetic disc 1 (an outer diameter area), the skew angle (this skew angle is referred to as a “positive angle”) is formed between a tangential direction LA of a track TA and a direction HA of the head slider 103. Further, when the head slider 103 is positioned near an edge of an inner diameter area of the magnetic disc 1 (an inner diameter area), the skew angle (this skew angle is referred to as a “negative angle”) is formed between a tangential direction LC of a track TC and a direction HC of the head slider 103.

Referring back to FIG. 1, the head amplifier 107 has a function of supplying an electric current to the recording element 150 mounted in the head slider 103 and performing information recording in the magnetic disc 1 based on a recording signal 113 transmitted from a read channel 116 which will be described later or a function of converting magnetized information of the magnetic disc 1 detected by the reproducing element 151 of the head slider 103 into a reproducing signal 114 and transmitting the reproducing signal 114 to the read channel 116.

The electrical circuit board 120 comprises the read channel 116, a micro processing unit (MPU) 115, a spindle motor driver 111, a voice coil motor (VCM) driver 112, a disc controller 117, and a memory 119 which comprises, for example, a flash memory.

The read channel 116 decodes and converts the reproducing signal 114 (a servo signal or a data signal) from the head amplifier 107 into digital information. Further, the read channel 116 converts information for which a recording instruction is issued from the disc controller 117 into the recording signal 113 for driving the head amplifier 107.

The MPU 115 drives the VCM through the VCM driver 112 and performs position determination control of the head slider 103 (the magnetic head (the recording element 150 or the reproducing element 151)) based on digital information (servo information) of the servo signal decoded by the read channel 116. Further, the MPU 115 drives the SPM 102 through the SPM driver 111 and performs rotation control of the magnetic disc 1.

The disc controller 117 instructs the MPU 115 to position the head slider 103 according to a recording/reproducing command from a host computer 118 and performs addressing of the head slider 103 (the magnetic head) to the magnetic disc 1. Further, the disc controller 117 performs an operation of transmitting or receiving digital information to be recorded/reproduced between the read channel 116 and the host computer 118 and replying the result to the host computer 118.

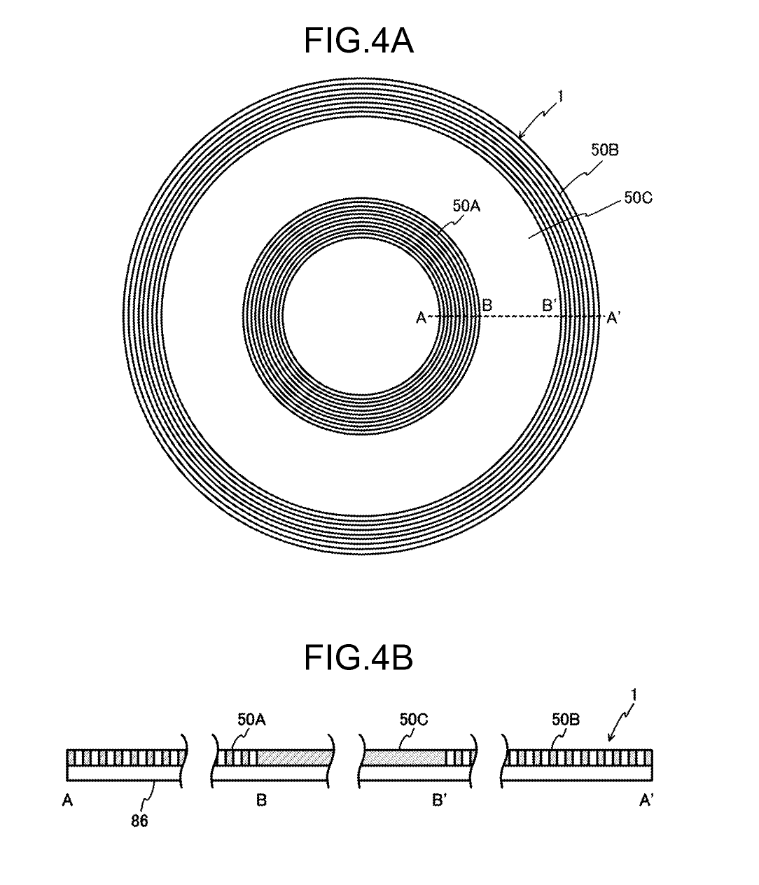

Next, the magnetic disc 1 of the first embodiment will be described in detail with reference to FIGS. 4A and 4B. FIG. 4A is a plane view of the magnetic disc 1. FIG. 4B is a cross-sectional view taken along line A-A′ of FIG. 4A.

As illustrated in FIGS. 4A and 4B, the magnetic disc 1 has a discoidal glass substrate 86, and a plurality (three in FIG. 4A) of areas (data storage areas) of a donut shape which are partitioned in the radial direction are formed on a surface of the glass substrate 86.

Among the three areas, in an inner diameter (between A and B in the cross-sectional view) area and an outer diameter (between B′ and A′ in the cross-sectional view) area, disposed are DTR recording layers 50A and 50B which comprise a track made of a magnetic material and a non-magnetic material (a guard band) which is disposed between tracks and physically partitions tracks. These areas may be also called discrete track recoding (DTR) areas 50A and 50B below. As the non-magnetic material, for example, SiO2 may be employed. Further, as the non-magnetic material, materials other than SiO2 such as Ni—Al may be employed. In the first embodiment, a track width and a difference between tracks (a track pitch) are equal.

In a middle diameter (between B and B′ in the cross-sectional view) area, a continuous recording layer 50C in which tracks are not partitioned by a non-magnetic material is disposed. This area will also be called continuous area 50C. The continuous recording layer 50C forms a first recoding layer, and the DTR recording layers 50A and 50B form a second recording layer. A radial direction length B-B′ of the middle diameter area (the continuous recording layer) 50C is set to about 30% to 70% of an overall radial length A-A′.

In the first embodiment, the radial direction length B-B′ of the middle diameter area is set to about 30% to 70% of the length A-A′ because of the reasons described below.

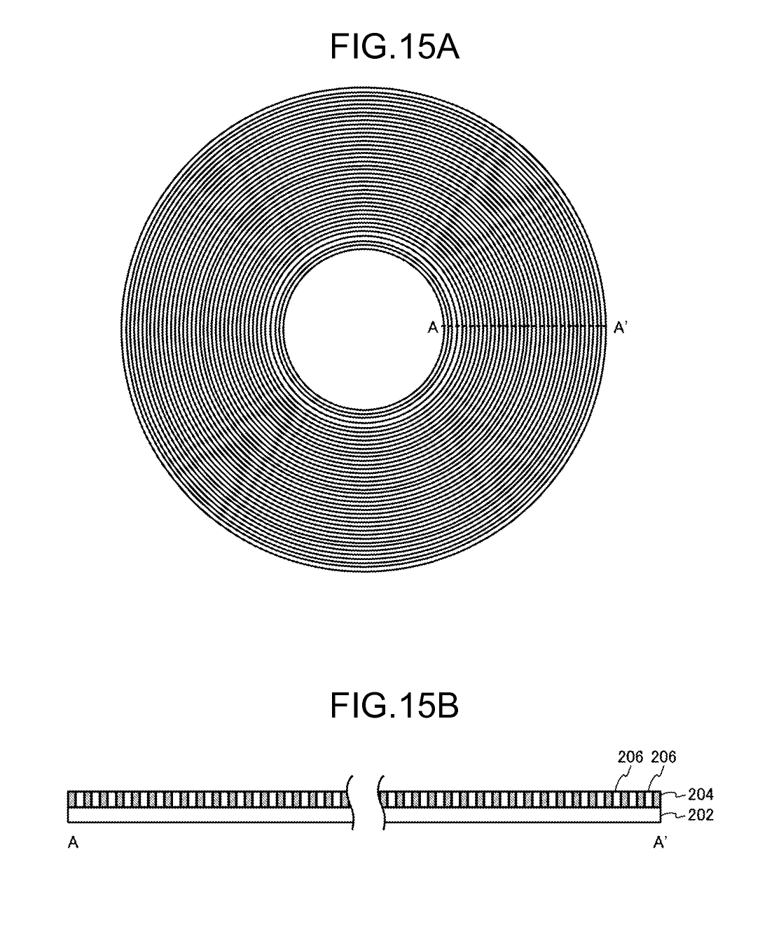

As will be described later, when a shape of a medium facing surface of the recording element 150 has an inverted trapezium shape other than a rectangle, the influence of leakage magnetic field recording caused by the skew angle can be reduced. As illustrated in FIG. 14A, the medium facing surface of the recording element 150 has an inverted trapezium shape having a taper angle α. Therefore, even though the skew angle is formed, when the skew angle θ is equal to or more than α (θ≧α) as illustrated in FIG. 14B, recording in which a track width is exceeded does not occur. However, when the skew angle θ is more than α (θ>α) as illustrated in FIG. 14C, adjacent track erasure is caused by the leakage magnetic field.

As the inverted trapezium taper angle of the recording element 150 is increased, the leakage magnetic field caused by the skew angle is further inhibited. However, when the taper angel is excessively increased, an area for generating magnetic flux is reduced, and switching magnetic field necessary for magnetic coercive force of the magnetic recording medium cannot be generated. Therefore, the taper angle is preferably set to a range of about 5° to 10°.

A skew angle range of the magnetic head depends on a range of an accessible radius of the magnetic disc, a rotation center position of the magnetic disc, a rotation center position of the carriage arm, and a length of up to the magnetic head. In a magnetic disc device of 2.5 inch type, the skew angle range of the magnetic head is around about 30° (±15°). When the inverted trapezium angle of the recording element is set to 5° to 10°, the skew angle in which the influence of the leakage magnetic field does not matter needs to be within an angle range equivalent thereto. That is, it can be said that a range of ⅓ to ⅔ of the accessible radius of the magnetic disc is an area which is small in influence of the leakage magnetic field. In addition, when a slight margin is considered, a radial length of the middle diameter area is preferably about 30% to 70% of an overall radial length of a recordable area.

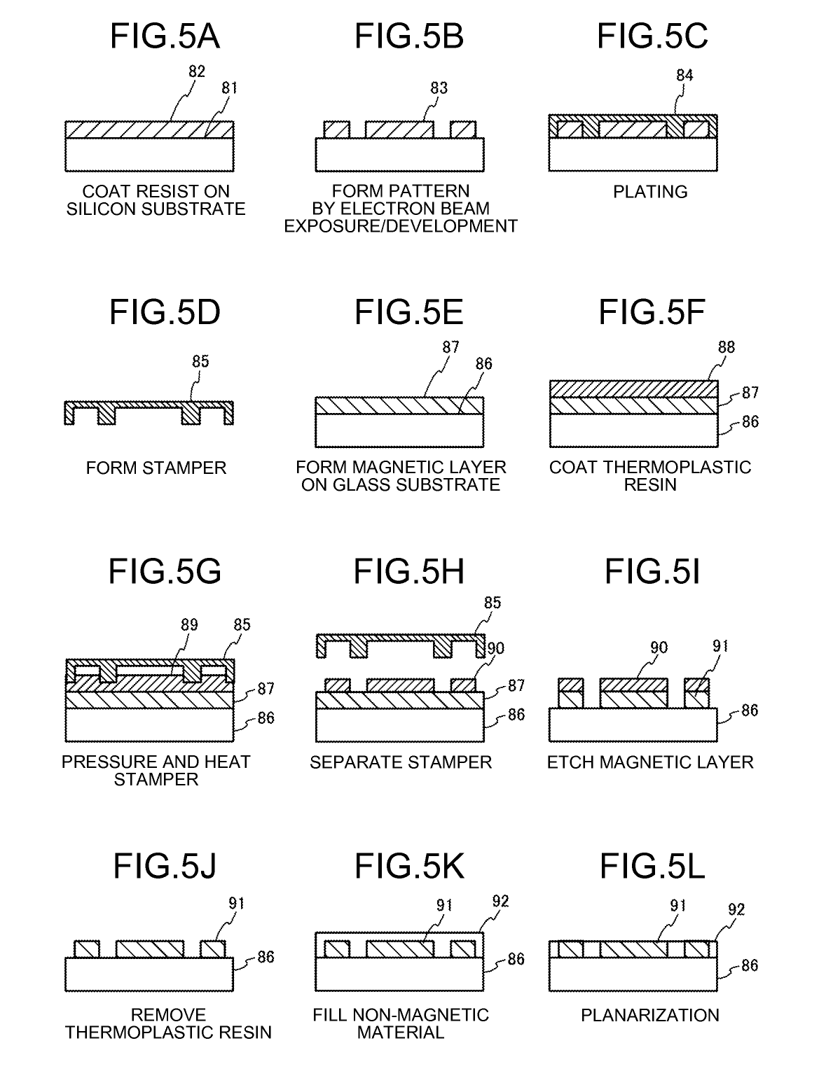

Next, a method of manufacturing the magnetic disc 1 will be described with reference to FIGS. 5A to 5L. To manufacture the magnetic disc 1, a nanoimprint lithography is employed.

First, as a process before manufacturing the magnetic disc 1, a nanoimprint stamper is manufactured by respective processes of FIGS. 5A to 5D. In detail, in FIG. 5A, a resist 82 is coated on a silicon substrate 81 by a spin coater (not illustrated) using a spin coating. In FIG. 5B, electron beam exposure using an electron beam (EB) exposure apparatus or development using a developing apparatus is performed to pattern the resist 82 (to obtain a patterned resist 83). In this case, a pattern of the resist 83 is identical to an arrangement of a magnetic material formed on the magnetic disc 1 after completion. In FIG. 5C, the resist 83 is plated by using, for example, nickel, to form a plating portion 84. In FIG. 5D, the plating portion 84 is separated from the patterned resist 83 so that a nanoimprint stamper 85 is obtained.

Subsequently, the magnetic disc 1 is manufactured by processes of FIGS. 5E to 5L by using the nanoimprint stamper 85 manufactured as described above.

In detail, in FIG. 5E, a layer 87 which is typically formed on a magnetic recording medium such as a magnetic layer is deposited on the glass substrate 86. Then, thermal nanoimprint is performed. FIGS. 5F to 5H illustrates the process of thermal nanoimprint. First, in FIG. 5F, a thermoplastic resin 88 which is resistant to etching is coated on the layer 87. In FIG. 5G, the thermoplastic resin 88 is pressured by the nanoimprint stamper 85 obtained in FIG. 5D while being heated. Therefore, a transformed resin layer 89 is formed.

Subsequently, in FIG. 5H, the nanoimprint stamper 85 is separated so that a patterned resin layer 90 remains. In FIG. 5I, only portions of the layer 87 which are not covered with the resin layer 90 are etched to thereby a patterned layer (a magnetic layer) 91. In FIG. 5J, the resin layer 90 present on the patterned magnetic layer 91 is removed. In FIG. 5K, a non-magnetic material 92 is filled on the patterned magnetic layer 91. In FIG. 5L, a surface of the non-magnetic material 92 is planarized by polishing or etching processing to expose the magnetic layer 91 and the non-magnetic material 92.

The magnetic disc 1 of the first embodiment can be manufactured by the above method. In the first embodiment, since thermal imprint is employed, the thermoplastic resin 88 is used in FIG. 5F. However, in the case of employing UV nanoimprint, ultraviolet (UV) curable resin may be used instead of the thermoplastic resin 88. Further, in the case of employing UV nanoimprint, the stamper needs to be made of a transparent material which transmits UV light such as quartz.

In the above manufacturing method, the magnetic layer is etched and patterned, and a non-magnetic material is formed in the patterned portion, but it is not so limited. For example, the magnetic layer is not patterned, but part (part corresponding to a non-magnetic guard band) of the magnetic layer may be ion-doped to form a DTR area in which a part of the magnetic layer is non-magnetized.

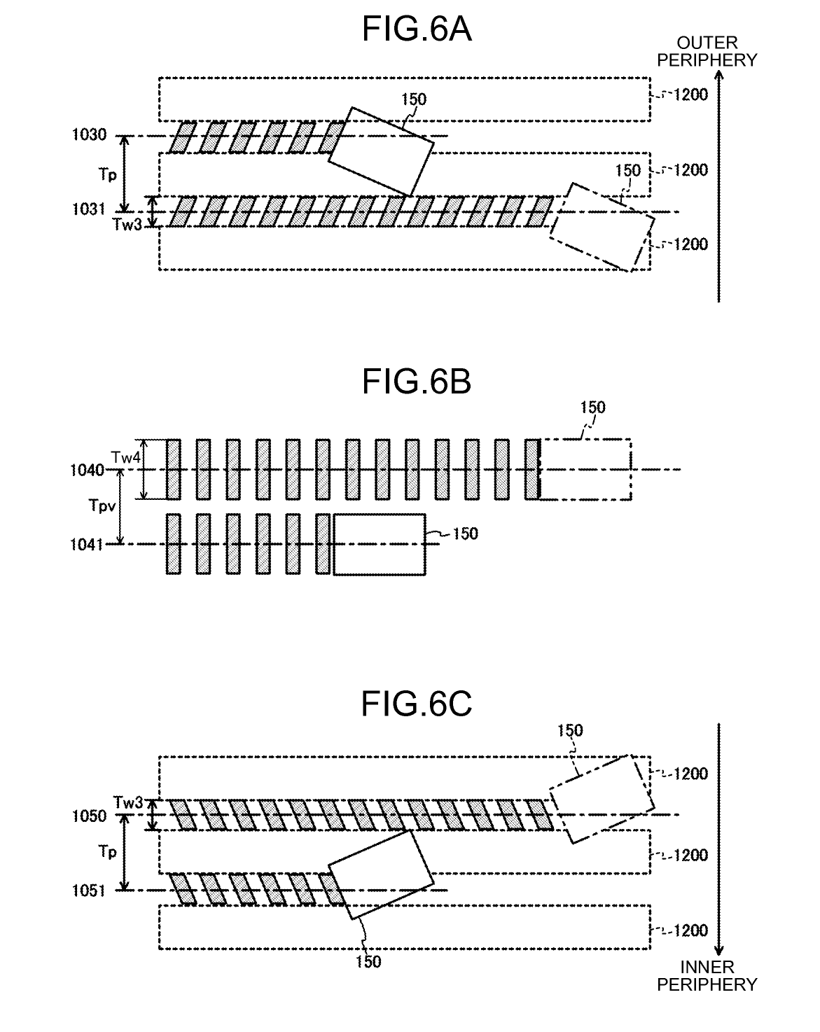

Next, a magnetic recording method and an information reproducing method according to the first embodiment will be described with reference to FIGS. 6A to 6C.

In FIG. 6A, reference numerals 1030 and 1031 denote tracks of the DTR area (DTR recording layer) 50B in the outer diameter (between B′ and A′ in the cross-sectional view) area of FIGS. 4A and 4B. In FIG. 6B, reference numerals 1040 and 1041 denote tracks of the continuous area (continuous recording layer) 50C in the middle diameter (between B and B′ in the cross-sectional view) area of FIGS. 4A and 4B. In FIG. 6C, reference numerals 1050 and 1051 denote tracks of the DTR area (DTR recording layer) 50A in the inner diameter (between A and B in the cross-sectional view) area of FIGS. 4A and 4B.

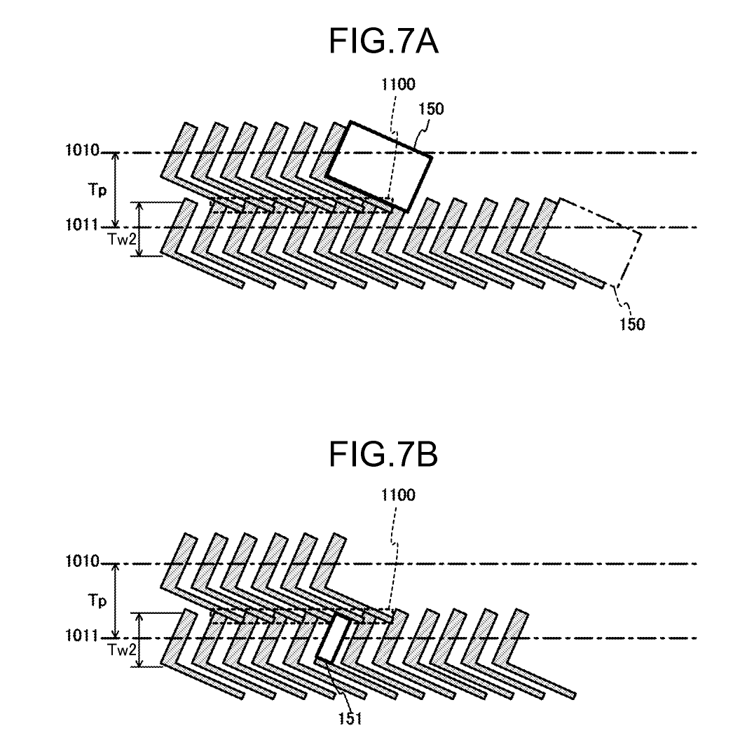

In the first embodiment, as illustrated in FIG. 6A, the skew angle is present between the recording element 150 and the track 1030 or 1031 in the outer diameter area. As illustrated in FIG. 7A, in the case where the DTR method is not employed, when a recording operation is performed in a track 1010, a magnetized pattern of a width Tw2 of the recording element 150 is formed on the magnetic disc 1, and at the same time, a magnetized pattern different form a necessary pattern is simultaneously formed in an inner direction (bottom in FIG. 7A) due to the influence of the leakage magnetic field from a side of the recording element 150. In this case, when an adjacent track is not present, the magnetized pattern is read by positioning the reproducing element with a width sufficiently narrower than the width Tw2 above the track 1010. However, when a magnetized pattern is formed in an adjacent track 1011, apart (inside a dashed-line frame 1100) of an outer direction of a magnetized pattern on the track 1010 is overwritten due to the influence of the leakage magnetic field as illustrated in FIG. 7B. Therefore, if the reproducing element 151 attempts to read the overwritten part, a necessary signal cannot be read. Further, not to read the overwritten part, a width of the reproducing element 151 needs to be narrowed as much as possible, but it is difficult to be realized because if an element width is much narrowed, a reproducing signal output is reduced.

However, in the first embodiment, as illustrated in FIG. 6A, a signal is recorded only in the tracks 1030 and 1031 with a width Tw3 due to the presence of the non-magnetic material guard band 1200 formed between the tracks. Therefore, the influence of the leakage magnetic field for the adjacent track 1031 when recording is performed in the track 1030 is greatly reduced compared to the conventional art. In the first embodiment, a track pitch (a track interval) Tp of the same width as in FIG. 7A is employed, and the influence of the leakage magnetic field between adjacent tracks can be avoided. Therefore, the recording density can be maintained, and recording/reproducing can be performed with high accuracy.

Similarly, the skew angle is present in the inner diameter area of the magnetic disc 1 as illustrated in FIG. 6C. However, in this case, the influence of the leakage magnetic field for the adjacent track 1050 at an outer area when recording is performed in the track 1051 is greatly reduced due to the presence of the non-magnetic material guard band 1200. Therefore, similarly to the outer diameter area, even in the inner diameter area, a track pitch Tp of the same width as in FIG. 7A is employed, and the influence of the leakage magnetic field between adjacent tracks can be avoided. Therefore, the recording density can be maintained, and recording/reproducing can be performed with high accuracy.

In the middle diameter area, since the recording area is the continuous area (the continuous recording layer), a track pitch can be variously changed. That is, in the first embodiment, a track pitch Tpv can be set for each medium according to characteristics of the recording element 150 and the reproducing element 151 of the disc apparatus in which the magnetic disc 1 is mounted. In this case, the track pitch Tpv is optimally determined to satisfy the recording capacity required in the whole apparatus and maximize a recording/reproducing margin such as an error rate or a signal to noise (S/N) ratio. As a result, an optimal track pitch according to characteristics of the recording element 150 and the reproducing element 151 can be selected, and thus the recording density can be further increased.

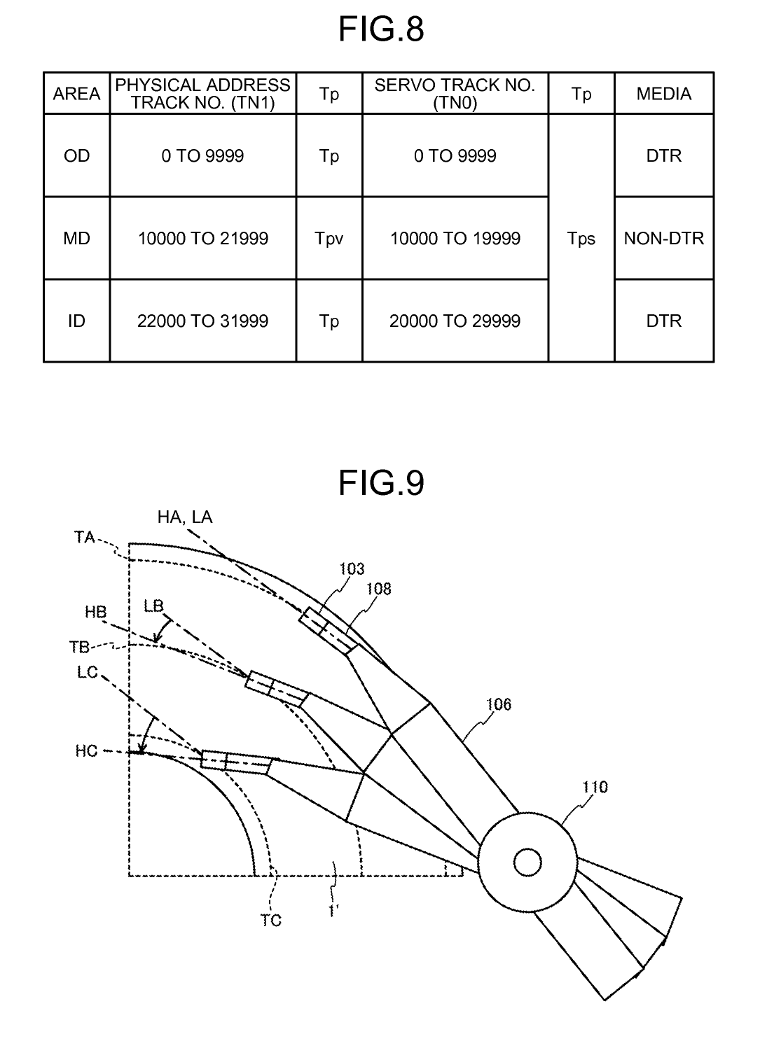

Next, a head position determination table (a track number conversion table) stored in the memory 119 of FIG. 1 in the first embodiment will be described with reference to FIG. 8.

A track number conversion table of FIG. 8 is a table for converting physical address track numbers TN1 into servo track numbers TN0 previously formed on the magnetic disc 1.

The servo track numbers TN0 are recorded at a regular interval Tps in the radial direction of the magnetic disc 1. In the magnetic disc 1, the physical address track numbers TN1 of the outer diameter area OD range from 0 to 9999, and since the outer diameter area OD is the DTR area (the DTR recording layer), the track pitch is set to a default value Tp. Further, since the servo track numbers are recorded to be synchronized one-to-one with the tracks of the DTR area, the default value Tp is equal to Tps, and the servo track numbers TN0 also range from 0 to 9999.

In the inner diameter area ID, since it is the DTR area (the DTR recording layer), the track pitch is set to a default value Tp.

Since the middle diameter area MD is the non-DTR area (the continuous area), the track pitch Tpv may be arbitrarily set according to a characteristic of the mounted magnetic head, and in the example of FIG. 8, Tpv=Tps/1.2. That is, in the middle diameter area MD, the track density is 1.2 times higher than in the outer diameter area OD and the inner diameter area ID. Therefore, in the middle diameter area MD, the physical address track numbers TN1 range from 10000 to 21999, while the servo track numbers TN0 range from 10000 to 19999.

In the first embodiment, a contact start stop (CSS) method may be employed. When the CSS method is employed, a CSS zone in which the head lands in the innermost area as an area other than the data storage area is set. In the case of a device which employs a lamp loading method, a landing area does not need to be set.

The table of FIG. 8 need not be necessarily stored in the memory 119 and may be magnetically stored in a system area on the magnetic disc 1.

Next, a method of recording/reproducing information with respect to the magnetic disc 1 using the track number conversion table of FIG. 8 will be described.

In FIG. 1, when an information recording/reproducing instruction is issued from the host computer 118 connected to the magnetic disc device 100, the disc controller 117 converts a logical address designated by the instruction into a physical address (a track number and a sector number of a magnetic disc medium) through a formatter (installed in the disc controller 117). The disc controller 117 instructs the MPU 115 to position the head at a position corresponding to the physical address. The MPU 115 converts the physical address track number TN1 into the servo track number TN0 which is previously formed on the magnetic disc 1 according to the track number conversion table of FIG. 8 stored in the memory 119.

Thereafter, the MPU 115 reads servo information on the magnetic disc 1, performs a control operation so that the magnetic head (the recording element 150 or the reproducing element 151) is to be positioned at the servo track number TN0 corresponding to the designated address, and issues a driving instruction to the VCM driver 112.

Accordingly, in the first embodiment, even if the DTR area and the non-DTR area (continuous area) are present together on the magnetic disc 1, appropriate recording/reproducing control can be performed.

As described above in detail, according to the first embodiment, the continuous recording layer 50C in which a magnetic material is deposited and the DTR recording layers 50A and 50B in which a magnetic material and a non-magnetic material are alternately arranged in an in-plane direction are allocated to a plurality of areas which are partitioned in the radial direction of the magnetic disc 1. Therefore, the DTR recording layers 50A and 50B are allocated to areas (the inner diameter area and the outer diameter area in the first embodiment) in which the influence by the leakage magnetic field for the adjacent track is expected to be large according to a position relationship between the magnetic head (the recording element 150 or the reproducing element 151) and the carriage actuator 105, whereby information recording accuracy is prevented from deteriorating. Further, the continuous recording layer 50C is allocated to, for example, an area in which the influence by the leakage magnetic field for the adjacent track is small, and thus the track pitch Tpv can be determined in consideration of the core width of the head. The track pitch in which a sufficient margin necessary for a reproducing signal to noise ratio (S/N) can be maintained and the recording density can be maximized is set according to characteristics of the recording and reproducing elements of the head, whereby the recording density of the magnetic disc 1 can be appropriately improved.

In the first embodiment, since a surface of the DTR recording layer and a surface of the continuous recording layer are flatly set, in both cases where the head slider 103 is positioned above the DTR recording layer and where the head slider 103 is positioned at continuous recording layer information, the same floating characteristic can be obtained. Therefore, there is no need for forming a landing zone described in, for example, Japanese Patent Application Publication (KOKAI) No. 2006-31850 or U.S. Pat. No. 7,199,977.

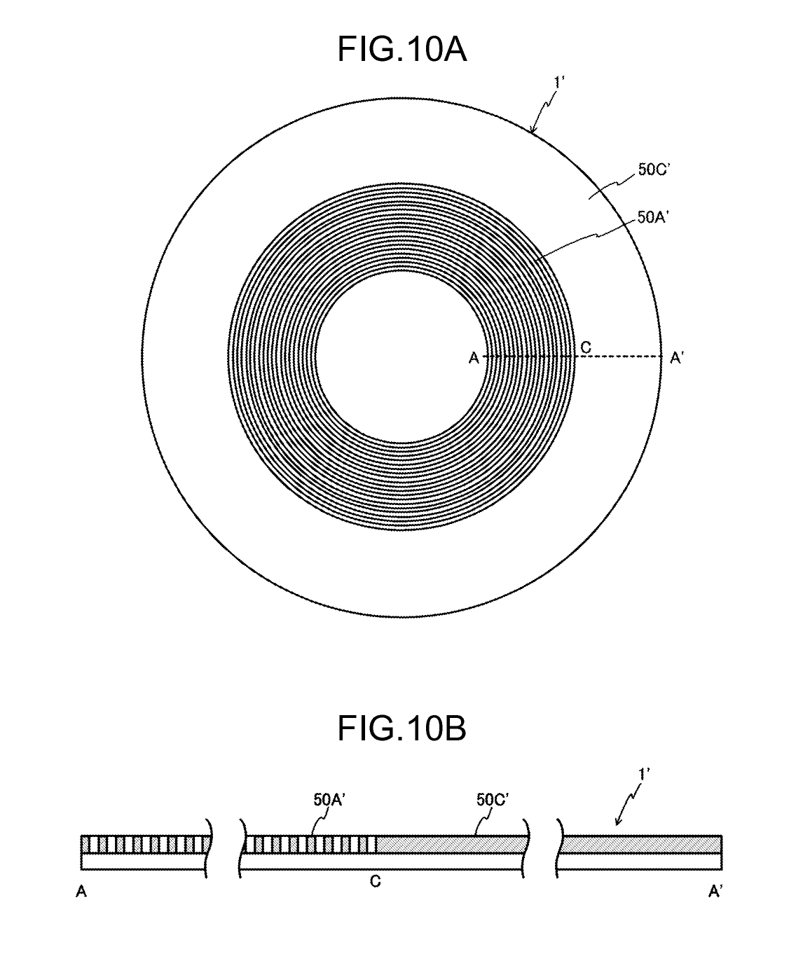

Next, a second embodiment of the invention will be described with reference to FIG. 9 and FIGS. 10A and 10B.

FIG. 9 illustrates a skew angle between a central line (a line which connects a center of the recording element 150 with a center of the reproducing element 151) of the head slider and a track tangent line in the second embodiment. In the second embodiment, the HGA 108 is fixed to have a fixed skew angle to the carriage arm 106. In the second embodiment, when the head slider 103 is positioned above an outer diameter track TA, the skew angle has an angle of around 0° to a track tangent line LA. Further, when the head slider 103 is positioned above a middle diameter track TB or above an inner diameter track TC, the head slider 103 has a negative skew angle to track tangent lines LB and LC.

As described above, in the second embodiment, as the head slider 103 is positioned on the inner diameter area of a magnetic disc 1′, the skew angle (an absolute value of the skew angle) is increased. Therefore, as the magnetic disc 1′, a magnetic disc illustrated in FIGS. 10A and 10B is employed. FIG. 10A is a plane view of the magnetic disc 1′. FIG. 10B is a cross-sectional view taken along line A-A′ of FIG. 10A.

As illustrated in FIGS. 10A and 10B, the magnetic disc 1′ is substantially discoidal, and an inner diameter area (between A and C in a cross-sectional view) has a DTR area (a DTR recording layer) 50A′ in which tracks are partitioned by a non-magnetic material. An outer diameter area (between C and A′ in the cross-sectional view) of the magnetic disc 1′ has a continuous area (a continuous recording layer) 50C′ in which tracks are not partitioned by a non-magnetic material. A radial length C-A′ of the continuous area 50C′ is set to about 30% to 70% of an overall length of A-A′. The reason that the continuous area 50C′ is set to this range is the same as described in the first embodiment.

A method of manufacturing the magnetic disc 1′ is the same as in the first embodiment.

As described above, according to the second embodiment, a configuration of the magnetic disc of the first embodiment is slightly changed in consideration of a change tendency of the skew angle, but similarly to the first embodiment, information recording accuracy of the DTR recording layer 50A′ can be inhibited from deteriorating, and information recording density of the continuous recording layer 50C′ can be improved.

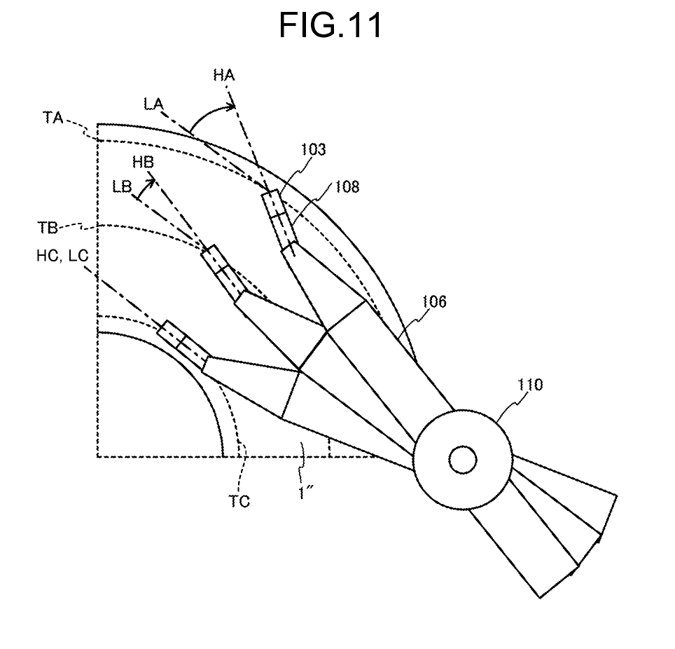

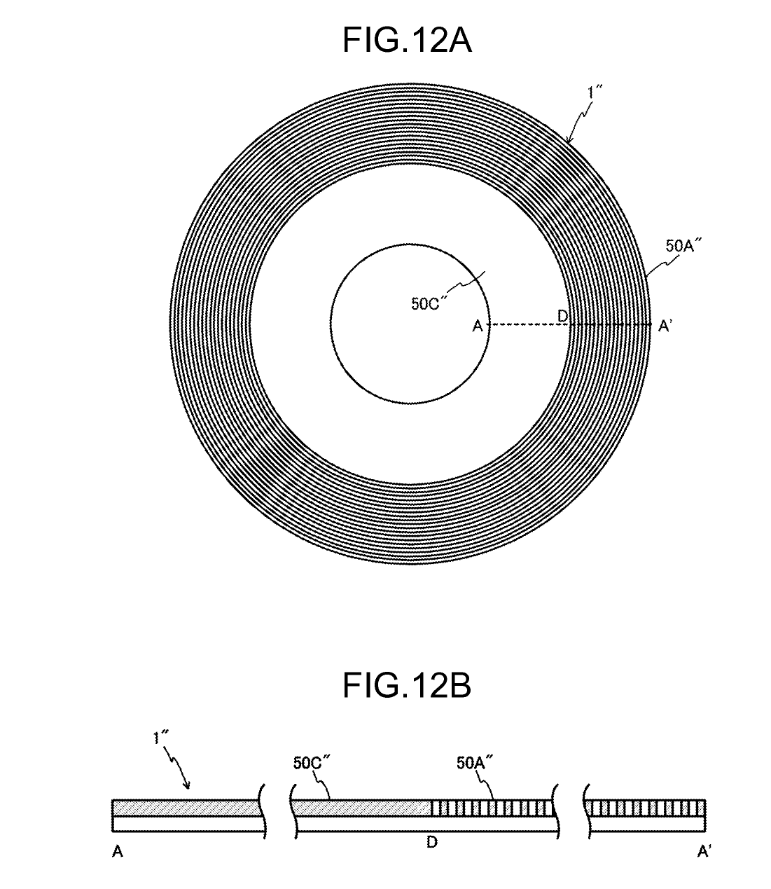

Next, a third embodiment of the invention will be described with reference to FIG. 11 and FIGS. 12A and 12B.

FIG. 11 illustrates a skew angle between a central line (a line which connects a center of the recording element 150 with a center of the reproducing element 151) of the head slider and a track tangent line in the third embodiment. In the third embodiment, when the head slider 103 is positioned above an inner diameter track TC, the skew angle has an angle of around 0° to a track tangent line LC. Further, when the head slider 103 is positioned above a middle diameter track TB or above an outer diameter track TA, the head slider 103 has a positive skew angle to track tangent lines LB and LA.

As described above, in the third embodiment, as the head slider 103 is positioned on the outer diameter area of a magnetic disc 1″, the skew angle is increased. Therefore, as the magnetic disc 1″, a magnetic disc illustrated in FIGS. 12A and 12B is employed. FIG. 12A is a plane view of the magnetic disc 1″. FIG. 12B is a cross-sectional view taken along line A-A′ of FIG. 12A.

As illustrated in FIGS. 12A and 12B, the magnetic disc 1″ is substantially discoidal, and an inner diameter area (between A and D in a cross-sectional view) has a continuous area (a continuous recording layer) 50C″ in which tracks are not partitioned by a non-magnetic material. An outer diameter area (between D and A′ in the cross-sectional view) of the magnetic disc 1″ has a DTR area (a DTR recording layer) 50A″ in which tracks are partitioned by a non-magnetic material. A radial length A-D of the continuous area 50C′ is set to about 30% to 70% of an overall length of A-A′. The reason that the continuous area 50C″ is set to this range is the same as described in the first embodiment. A method of manufacturing the magnetic disc 1′ is the same as in the first embodiment.

As described above, according to the third embodiment, a configuration of the magnetic disc of the first embodiment is slightly changed in consideration of a change tendency of the skew angle, but similarly to the first and second embodiments, information recording accuracy of the DTR recording layer 50A″ can be inhibited from deteriorating, and information recording density of the continuous recording layer 50C″ can be improved.

In the first to third embodiments, the track pitch and the track width of the discrete track area are described as being uniform. However, this is by way of example and not of limitation, and the track pitch or the track width may be changed according to a change tendency of the skew angle.

In the first to third embodiments, the discrete track area is described as being provided in an area in which the skew angle is increased. However, this is by way of example and not of limitation. Instead of the discrete track, a recording area (a discrete bit area) in bit-pattern form in which a magnetic material is portioned into bits by a non-magnetic material may be set.

In the first to third embodiments, materials such as SiO2 and Ni—Al are cited as examples of non-magnetic material which configures the discrete track; however, the non-magnetic material is not limited thereto, and air may be used as the non-magnetic material. That is, a space between the magnetic materials may not be filled with any special material.

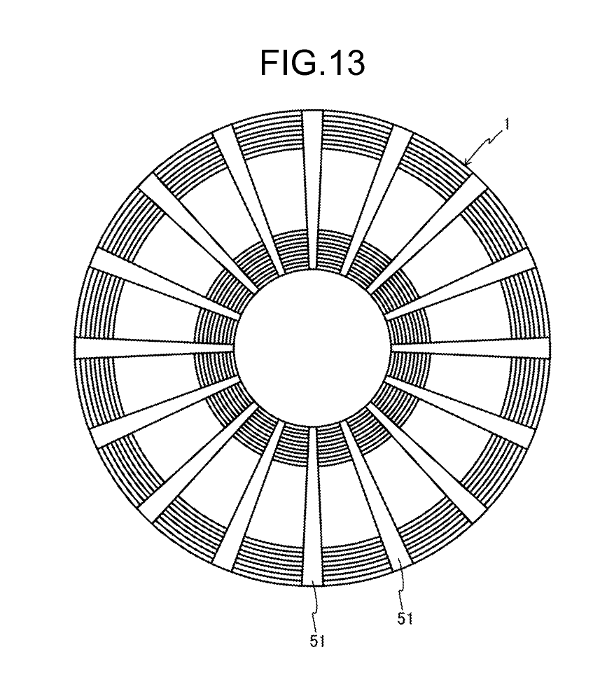

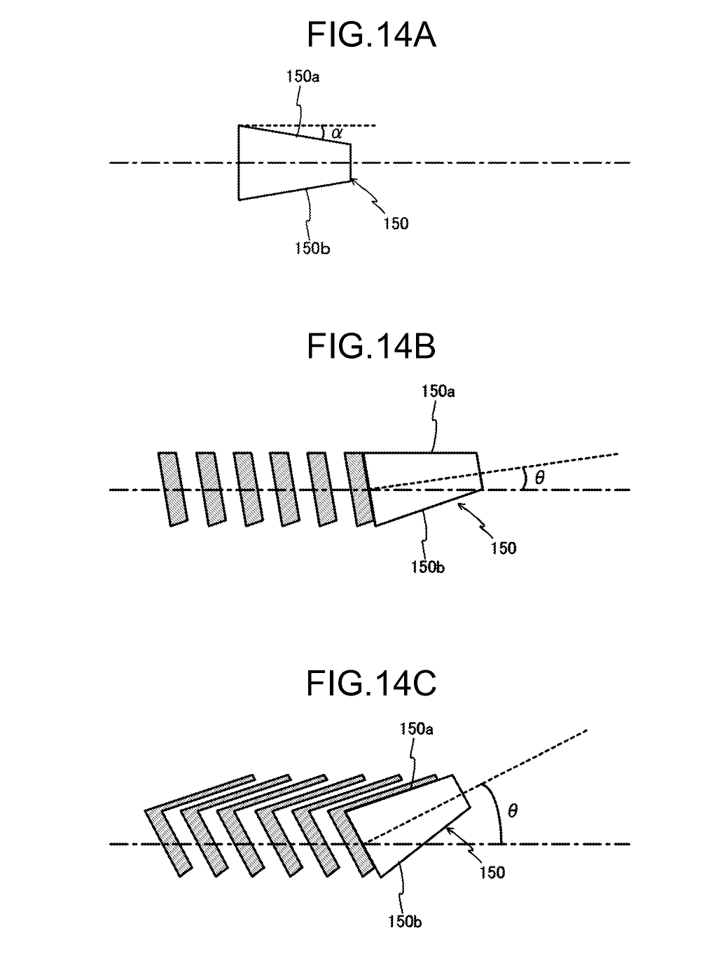

Although not described in the first to third embodiments, servo pattern areas 51 are radially set in the magnetic disc of each of the first to third embodiments as illustrated in FIG. 13. The servo pattern areas are intermittently formed at a regular interval in a circumferential direction. Servo patterns in the servo pattern areas are read by using the recording element 150 while the magnetic disc 1 is rotating, and so radial position information can be obtained at a specific time interval.

Similarly to the DTR area, the servo pattern may be previously formed in the stamper of the nanoimprint lithography as a pattern by a non-magnetic material and a magnetic material. A magnetic material in the servo pattern area needs to be magnetized in a single direction. The servo pattern may also be recorded by using the recording element 150. In this case, the inside of the servo pattern area is a continuous area which is not partitioned by a non-magnetic material.

In the first to third embodiments, the recording element 150 is described as having a rectangular cross-sectional shape. However, this is by way of example and not of limitation. As illustrated in FIG. 14A, a recoding element 150′, whose cross-sectional shape is a shape (isometric trapezoid (isosceles trapezoid) shape) obtained by inclining facing sides 150a and 150b of a rectangle by α°, may be employed. In this case, as illustrated in FIG. 14B, protrusion recording does not occur between an angle (θ=α) in which the side 150a becomes parallel with a tangential direction (a direction denoted by a dashed dot line) of a track and an angle (θ=−α) until the side 150b becomes parallel with a tangential direction of a track. Therefore, in the magnetic disc, a range (a range in which the skew angle θ satisfies Equation 1) in which protrusion recording does not occur may be set as a continuous area (a continuous recording layer).

−α≦θ≦α (1)

As illustrated in FIG. 14C, when the skew angle θ does not satisfy Equation (1), protrusion recording occurs. Therefore, a range (a range which does not satisfy Equation 1) in which protrusion recording occurs may be set as the DTR area (the DTR recording layer).

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic recording medium comprising:
a disc substrate;
a first recording layer in a first at least one data storage area partitioned in a radial direction on the disc substrate, comprising a magnetic material on the first recording layer; and
a second recording layer in a second at least one data storage area, the second recording layer comprising a magnetic material and a non-magnetic material alternately arranged in an in-plane direction of an upper surface of the disc substrate.

2. The magnetic recording medium of claim 1, wherein the magnetic material and the non-magnetic material of the second recording layer are alternately arranged in a concentric circular manner.

3. The magnetic recording medium of claim 1, wherein the magnetic material of the second recording layer is in a bit-pattern.

4. The magnetic recording medium of claim 1, wherein a radial direction length of the first data storage area on the disc substrate is 30% to 70% of a radial direction length of all the data storage areas.

5. A magnetic storage device comprising:
a magnetic head configured to record information and reproduce information with respect to a magnetic recording medium, the magnetic recording medium comprising:
a disc substrate,
a first recording layer in a first at least one data storage area partitioned in a radial direction on the disc substrate, comprising a magnetic material on the first recording layer, and
a second recording layer in a second at least one data storage area, the second recording layer comprising a magnetic material and a non-magnetic material alternately arranged in an in-plane direction of an upper surface of the disc substrate;
a head mount configured to support the magnetic head; and
a driver configured to move the head mount around a pivot and to position the magnetic head on the first recording layer or the second recording layer.

6. The magnetic storage device of claim 5, wherein a surface of the first recording layer and a surface of the second recording layer of the magnetic recording medium are configured to be flat.

7. The magnetic storage device of claim 5, wherein
a skew angle of the magnetic head is larger as the magnetic head is closer to either an outer diameter area or an inner diameter area of the magnetic recording medium, and
the second recording layer is in an outermost area and an innermost area of the data storage areas of the magnetic recording medium.

8. The magnetic storage device of claim 5, wherein
a skew angle of the magnetic head is larger as the magnetic head is closer to an outer diameter area of the magnetic recording medium, and
the second recording layer is in an outermost area of the data storage areas of the magnetic recording medium.

9. The magnetic storage device of claim 5, wherein
a skew angle of the magnetic head is larger as the magnetic head is closer to an inner diameter area of the magnetic recording medium, and
the second recording layer is in an innermost area of the data storage areas of the magnetic recording medium.

10. The magnetic storage device of claim 5, wherein
the magnetic head comprises a recording element,
a surface of the recording element facing the magnetic recording medium is in an isosceles trapezoid shape by decreasing two angles of a rectangle by α°, and
the second recoding layer is in a data storage area of the magnetic recording medium where a skew angle θ of the magnetic head does not satisfy −α°≦θ≦α°.
